(19) United States
(12) Patent Application Publication
(10) Pub. No.: US 2016/0217510 A1
(43) Pub. Date: Jul. 28, 2016

(54) APPARATUS, METHOD, AND COMPUTER-READABLE MEDIUM THAT TRANSMIT ACCUMULATED TOTAL MEASURE TO AN EXTERNAL DEVICE

(71) Applicant: CHARLOTTESVILLE PARKING CENTER, INC., Charlottesville, VA (US)

(72) Inventor: William Mark BROWN, Charlottesville, VA (US)

(73) Assignee: CHARLOTTESVILLE PARKING CENTER, INC., Charlottesville, VA (US)

(21) Appl. No.: 14/965,211

(22) Filed: Dec. 10, 2015

Related U.S. Application Data
(60) Provisional application No. 62/106,598, filed on Jan. 22, 2015.

(51) Int. Cl. G06Q 30/02

(52) U.S. Cl. CPC G06Q 30/0284

(57) ABSTRACT

An apparatus, method, and computer-readable medium, the apparatus including processing circuitry configured to determine a first validation based on a first activity performed at a first location, which is determined based on a sensor of an external device, determine a second validation based on a second activity performed at a second location, which is determined based on the sensor of the external device, the second location being different from the first location, compute a total validation by aggregating the first validation and the second validation, calculate a total measure by adjusting an initial measure by the total validation, the initial measure corresponding to an amount that fluctuates based on predetermined conditions associated with a time of day and total amount of time spent at a geographical location that includes the first location and the second location, and transmit, via a network, the calculated total measure to the external device.

### CROSS-REFERENCE TO RELATED APPLICATIONS

This application is based upon and claims the benefit of priority under 35 U.S.C. §119(e) from U.S. Ser. No. 62/106,598, filed on Jan. 22, 2015.

### BACKGROUND

1. Field of the Disclosure

This application relates generally to improvements in an apparatus, method, and computer-readable medium that determine validations and calculate a total measure based on the validations.

2. Description of the Related Art

Urban shopping districts are ordinarily traveled to by both employees of stores in the shopping districts and shoppers alike. The transportation methods can be roughly grouped into three categories: first, transportation methods which require little or no civil infrastructure support, such as walking, bicycling, or the use of Segway® or similar personal transporters; second, public and private transportation methods which may require civil infrastructure support but do not require parking infrastructure, such as public transit systems, taxi cabs, free shuttles or trolley services; and third, private vehicles requiring on-street or off-street parking infrastructure. While all these transportation methods may be individually directed to allow convenient and affordable access to an urban shopping area, in implementation these methods are frequently in competition with one another for funding and infrastructure, and in practice each method frequently limits the contributions and benefits of the other methods.

While walking and bicycling to an urban shopping district are free and place the least burden on the public infrastructure, only a small portion of an urban population will be able to travel in such fashion. Further, the logistics of having to return home with any purchases severely limits the size and quantity of purchases. Thus, while they are an excellent means of transportation for a small number of employees and customers near an urban shopping district, walking and bicycling alone cannot support a robust shopping district in an urban setting.

The next least burdensome means of transportation for civil infrastructure are modes which require no public or private parking infrastructure. However, these modes tend to be either slow or expensive. While mass transit trains and buses are relatively inexpensive, to travel any considerable distance on them usually entails substantial amount of time. Passengers have to arrive at the departure point in advance of a scheduled departure time, wait for the mass transportation vehicle to arrive, pass through all the stops between the departure and destination stops, make transfers, and walk from the destination stop to a merchant location. Faced with the time required to travel via public transportation, traveling via private commercial transportation presents itself as another option which does not require parking infrastructure; however, this is the most expensive means of transportation for a passenger.

Given the narrow availability of walking or bicycling, and the choice between slow, inexpensive transportation and fast, expensive transportation, many employees and patrons of an urban shopping district will simply choose to utilize their own private vehicles. While this option may frequently be the most convenient for an individual, it also has the highest cost to the community as it places the greatest burden on civil infrastructure in terms of required parking availability, traffic congestion, and road maintenance and replacement costs.

Thus, none of the above-identified means of transportation is sufficient on its own in an urban environment.

The present embodiment solves the problem of lack of convenient and affordable access to urban shopping areas by implementing an integrated transportation and parking solution, which integrates public and private transportation means, public and private parking, payment, and merchant validation of both transportation and parking fees.

### SUMMARY

An apparatus, method, and computer-readable medium that determine a first validation based on a first activity performed at a first location, which is determined based on a sensor of an external device that is external to the apparatus, determine a second validation based on a second activity performed at a second location, which is determined based on the sensor of the external device, the second location being different from the first location, compute a total validation by aggregating the first validation and the second validation, calculate a total measure by adjusting an initial measure by the total validation, the initial measure corresponding to an amount that fluctuates based on predetermined conditions associated with a time of day and total amount of time spent at a geographical location that includes the first location and the second location, and transmit, via a network, the calculated total measure to the external device.

The forgoing general description of the illustrative implementations and the following detailed description thereof are merely exemplary aspects of the teachings of this disclosure, and are not restrictive.

### BRIEF DESCRIPTION OF THE DRAWINGS

A more complete appreciation of the disclosed embodiments and many of the attendant advantages thereof will be readily obtained as the same becomes better understood by reference to the following detailed description when considered in connection with the accompanying drawings, wherein:

FIG. 1 is an exemplary layout of a downtown access system including a parking system according to an embodiment of the present disclosure.

FIG. 2 illustrates a sample client-server based architecture of a downtown access system application according to an embodiment of the present disclosure.

FIG. 3A illustrates a first screen of a sample interface of the DAS app according to an embodiment of the present disclosure.

FIG. 3B illustrates a second screen of the sample interface of the DAS app according to an embodiment of the present disclosure.

FIG. 3C illustrates a third screen of the sample interface of the DAS app according to an embodiment of the present disclosure.

FIG. 3D illustrates a fourth screen of the sample interface of the DAS app according to an embodiment of the present disclosure.

FIG. 3E illustrates a fifth screen of the sample interface of the DAS app according to an embodiment of the present disclosure.

FIG. 3F illustrates a sixth screen of the sample interface of the DAS app according to an embodiment of the present disclosure.

FIG. 3G illustrates a seventh screen of the sample interface of the DAS app according to an embodiment of the present disclosure.

FIG. 4 illustrates a sample database stored on a server according to an embodiment of the present disclosure.

FIG. 5A illustrates a validation process based on user activities according to an embodiment of the present disclosure.

FIG. 5B illustrates a validation process performed by the server according to an embodiment of the present disclosure.

FIG. 6 illustrates a time-based route determination algorithm according to an embodiment of the present disclosure.

FIG. 7 illustrates a cost-based route determination algorithm according to an embodiment of the present disclosure.

FIG. 8 illustrates a flow chart for determining a remaining time and an estimated available time for on-street parking according to an embodiment of the present disclosure.

FIG. 9 is a detailed block diagram illustrating an exemplary user device according to certain embodiments of the present disclosure.

FIG. 10 is a detailed block diagram illustrating an exemplary server according to certain embodiments of the present disclosure.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise. The drawings are generally drawn to scale unless specified otherwise or illustrating schematic structures or flowcharts.

Furthermore, the terms “approximately,” “proximate,” “minor,” and similar terms generally refer to ranges that include the identified value within a margin of 20%, 10% or preferably 5% in certain embodiments, and any values therebetween.

The terms “user”, “customer”, and “employee” are used interchangeably to refer to a person using an access system.

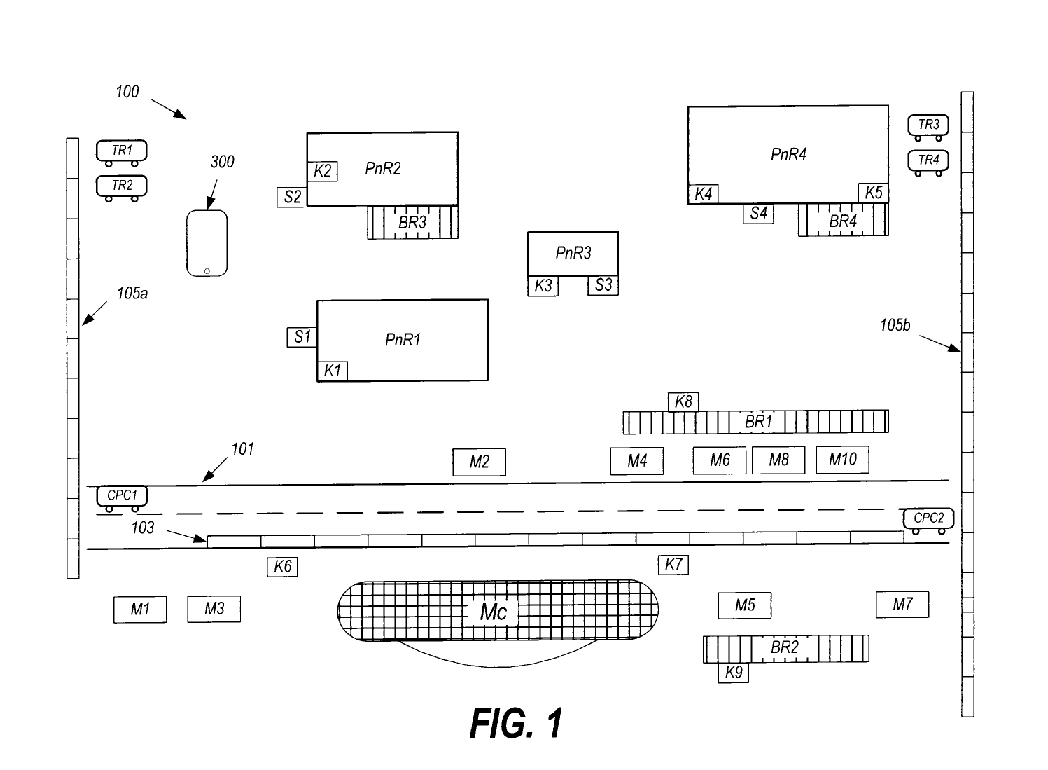

FIG. 1 is an exemplary layout of an access system including a parking system according to an embodiment of the present disclosure. The access system includes several facilities and services such as merchant M1-M10, a merchant center Mc, a street 101, on-street parking 103 with several parking spots, rail tracks 105a and 105b, multiple parking lots PnR1-PnR4, multiple bike racks BR1-BR4, several kiosks K1-K9, multiple free trollies TR1-TR4, and bus services such as buses CPC1 and CPC2. Furthermore, car sharing services may have dedicated parking spots, for example on-street or in a parking lot, available in an area (e.g., a city center or downtown area).

A parking lot has a kiosk machine for making payments for car parking and a status reporter that indicates parking availability in a particular parking lot. For instance, a parking lot PnR1 is associated with a kiosk K1 and a status reporter S1, a parking lot PnR4 associated with two kiosks, kiosk K4 and kiosk K5, and a status reporter S4, etc. Further the parking lot may include a bike rack. For instance, the parking lot PnR4 includes a bike rack BR4. Additional bike racks may be provided close to the merchants such as the bike rack BR1 provided close to merchant M4-merchant M10, and the bike rack BR2 provided close to the merchant center Mc. A bike rack is also associated with a kiosk machine. Each of the parking lots and the bike racks may have different storing capacity. For instance parking lot PnR1 may provide parking for 100 vehicles while parking lot PnR4 may provide parking for 800 vehicles. Similarly, the bike rack BR1 can provide and hold more than 25 bikes (for example) while bike rack BR2 can provide and hold say less than 10 bikes (for example). The parking lots and the bike racks may be used by customers or employees of merchants that use a personal vehicle. Additional parking can be provided on-street.

Kiosks K1-K9 can be accessed wirelessly and can include several payment options. For example, a LUKE II kiosk provides a wide range of payment options such as coins, credit cards, smart cards, or pay-by-phone, a parking expiry reminder, extend time via software application, contactless payment option such as MASTERCARD, PAYPASS etc.

The area parking system includes several transport modes such as free trolleys from the parking lots, bikes from the parking lots, buses, taxis, or walkways to travel to a desired merchant. Customers or employees can use one or a combination of transportation modes to reach the desired merchant, each combination having certain advantages. For instance, a customer going to the merchant center Mc can drive a personal vehicle and park in the parking lot PnR2, ride a bike from the BR3 to the bike rack BR2 and walk to the merchant center Mc. A customer may also use public transport such as a train or a bus in combination with the free trolley and walking. A particular combination of transportation mode may have comparatively lower cost while another combination may be comparatively faster. A choice of transit mode can be made based on one's situation and priorities. Thus, the access system provides flexibility in many different ways for the customers and employees.

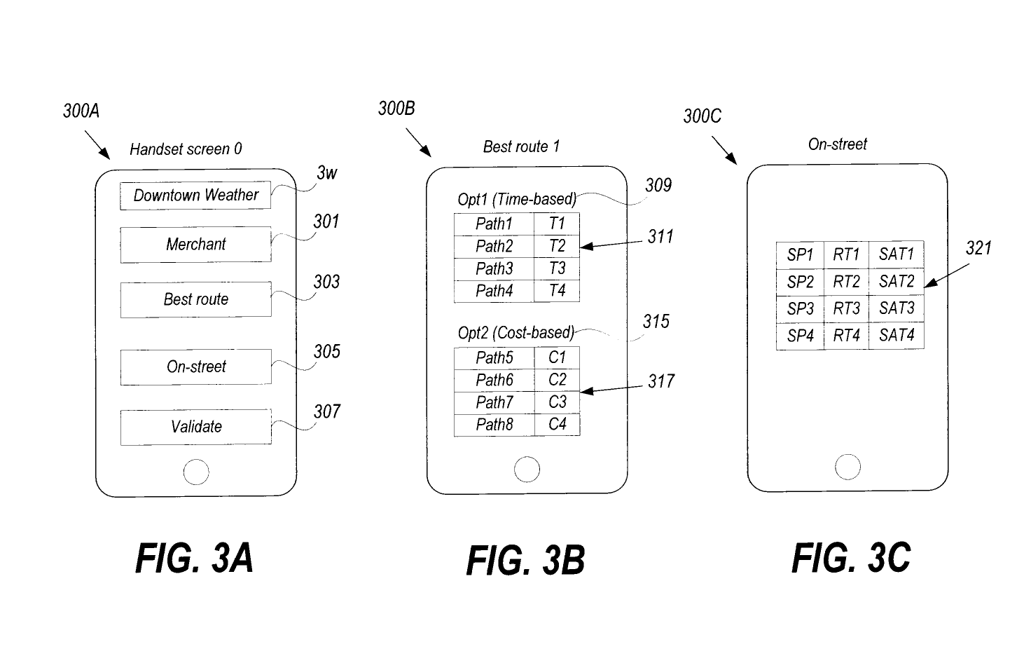

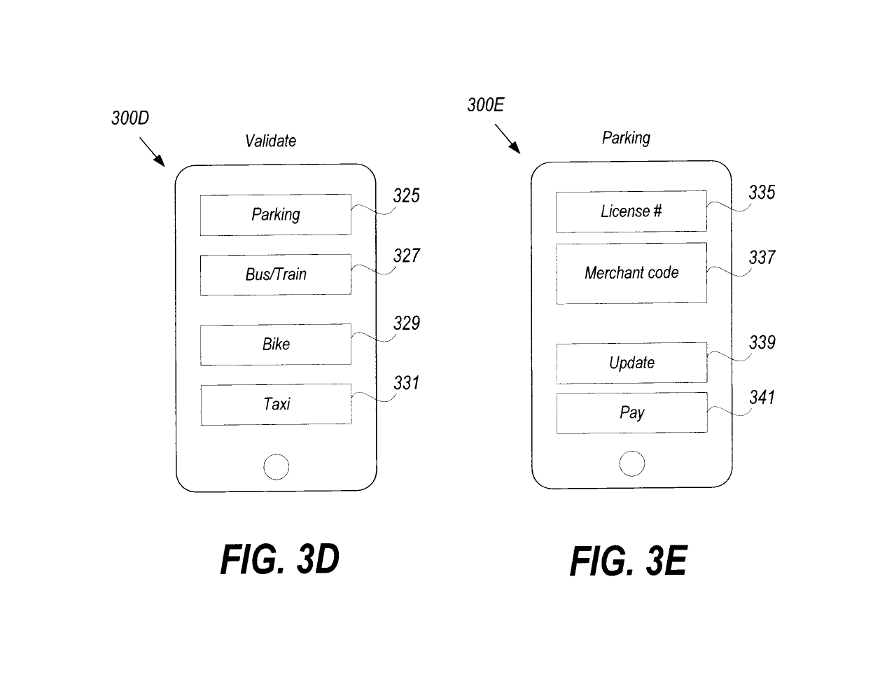

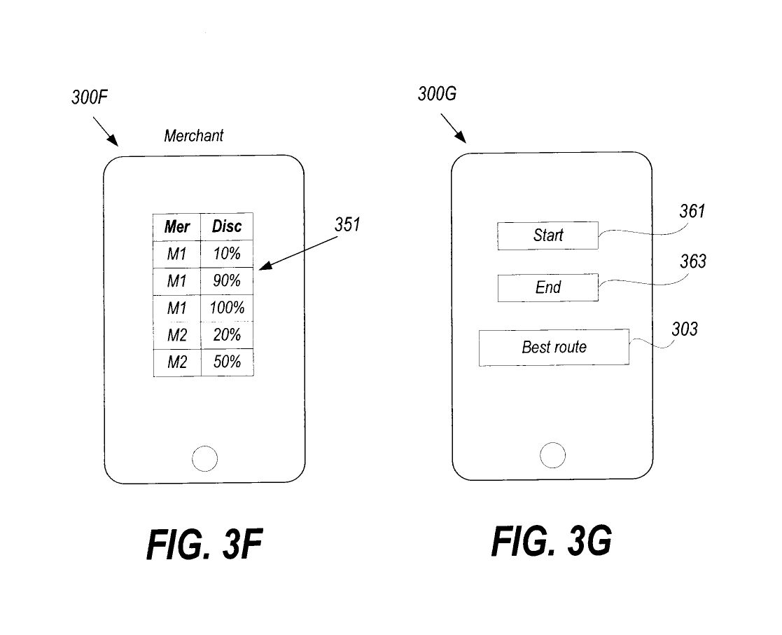

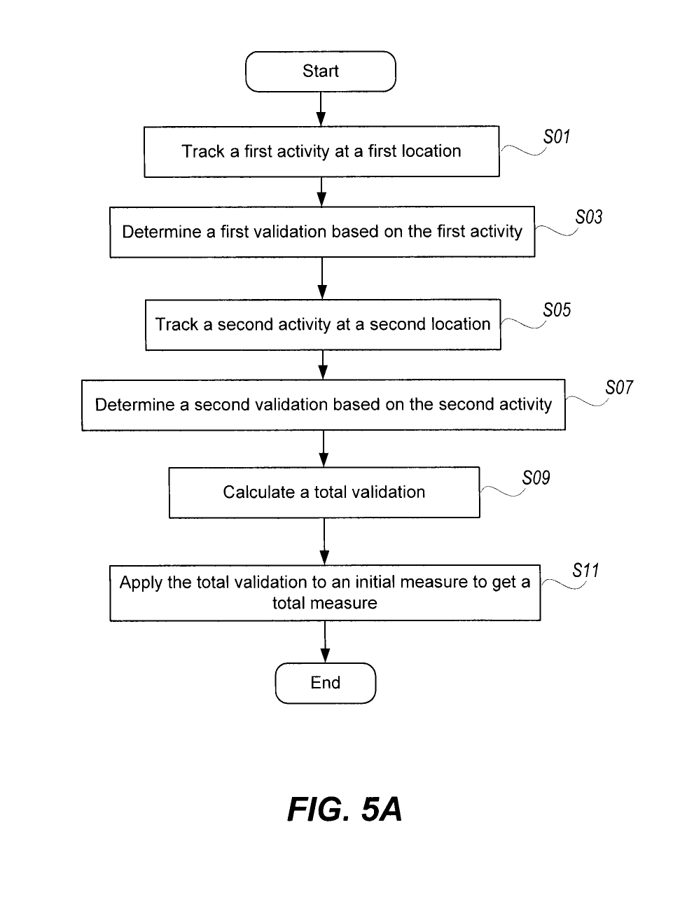

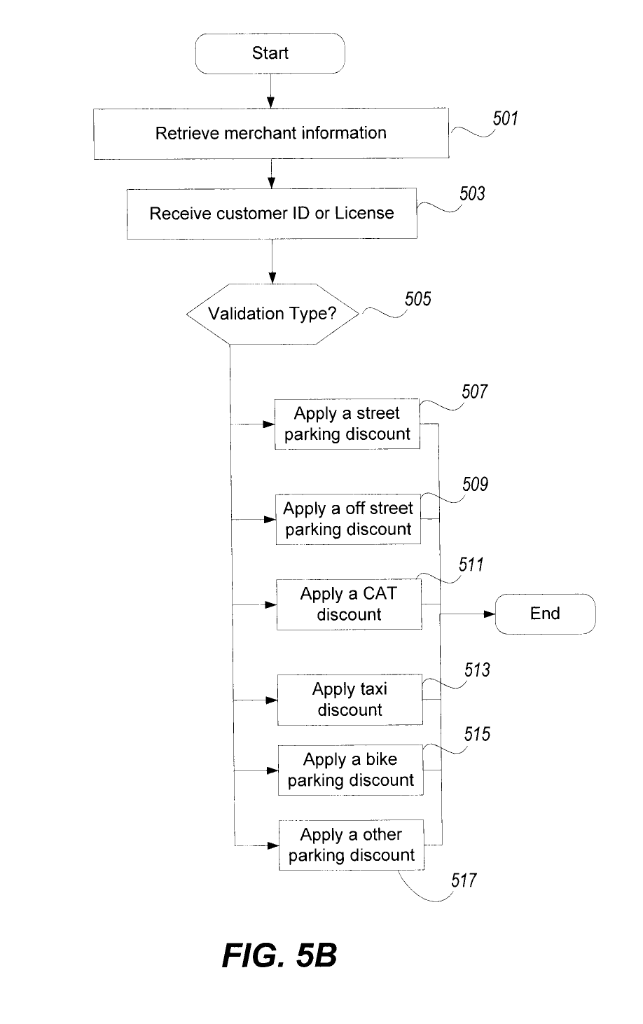

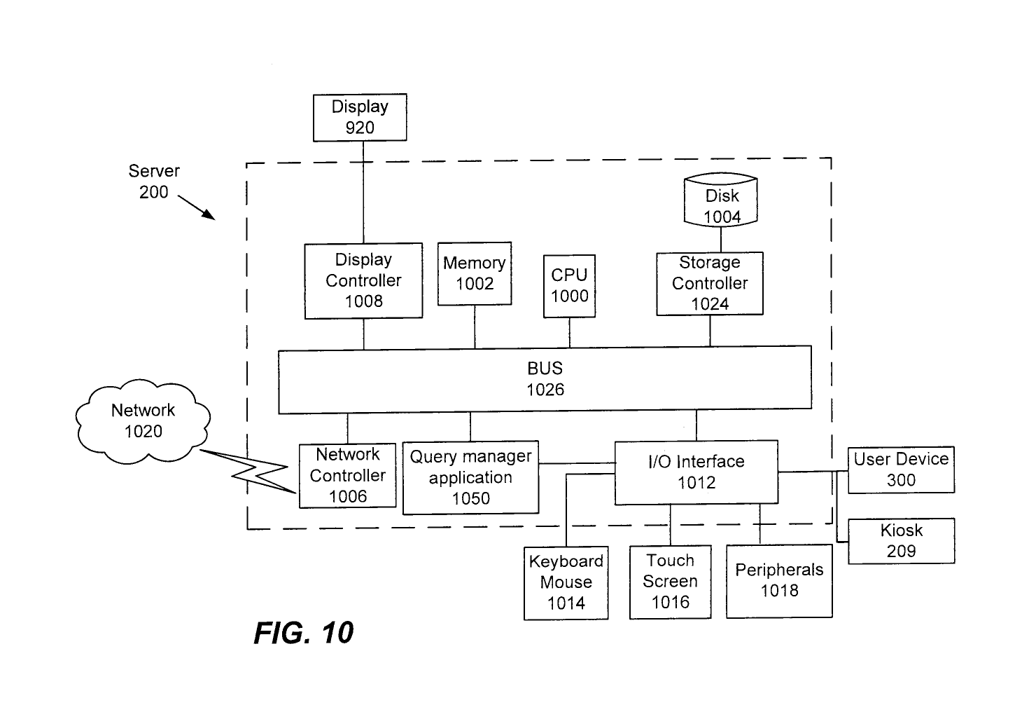

In order to handle the complex network of the access system in an integrated manner and provide additional convenience to the customers and employees, a access system application (hereafter referred as “DAS app”) is provided that can be deployed on a device such as a smartphone, tablet, or a computer. The DAS app provides several features such as real time on-street and off-street parking information, public transport information, taxi information, and merchant validation. In one embodiment, devices are programmed via software to provide the functionalities discussed in the present disclosure, for example, functions described with respect to FIGS. 3A-3G and 5A-5B. When executed on a device such software is referred to as an “app.” As discussed below, the DAS app is executed on a user device 300, which sends requests for data processing to a server 200 (in FIG. 10) via a query manager application executed on the server 200.

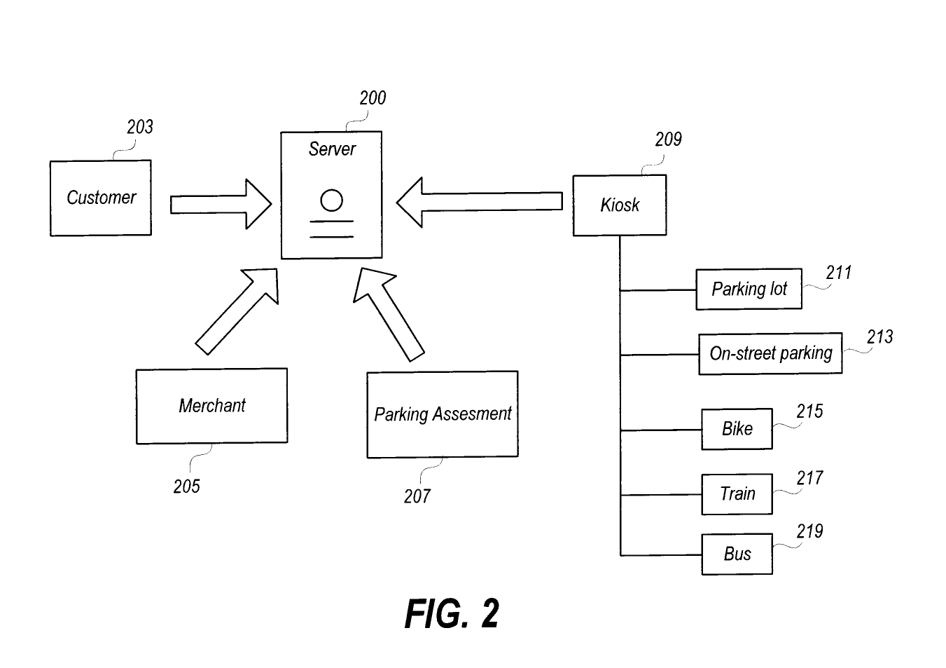

FIG. 2 illustrates a sample client-server based architecture of the access system according to an embodiment of the present disclosure. The access system includes a server 200 which acts as a central information database that contains past as well as real-time information related to the parking system such as the one discussed above with respect to FIG. 1. The server 200 processes and communicates information to different clients such as a customer 203, a merchant 205, a parking assessment 207, and a kiosk 209. The customer 203 can send and receive information from the server 200 using the DAS app executed on the user device 300. Further, the DAS app can be configured to send and receive signals from the kiosk 209, for example, signal(s) to extend time, make a payment, etc.

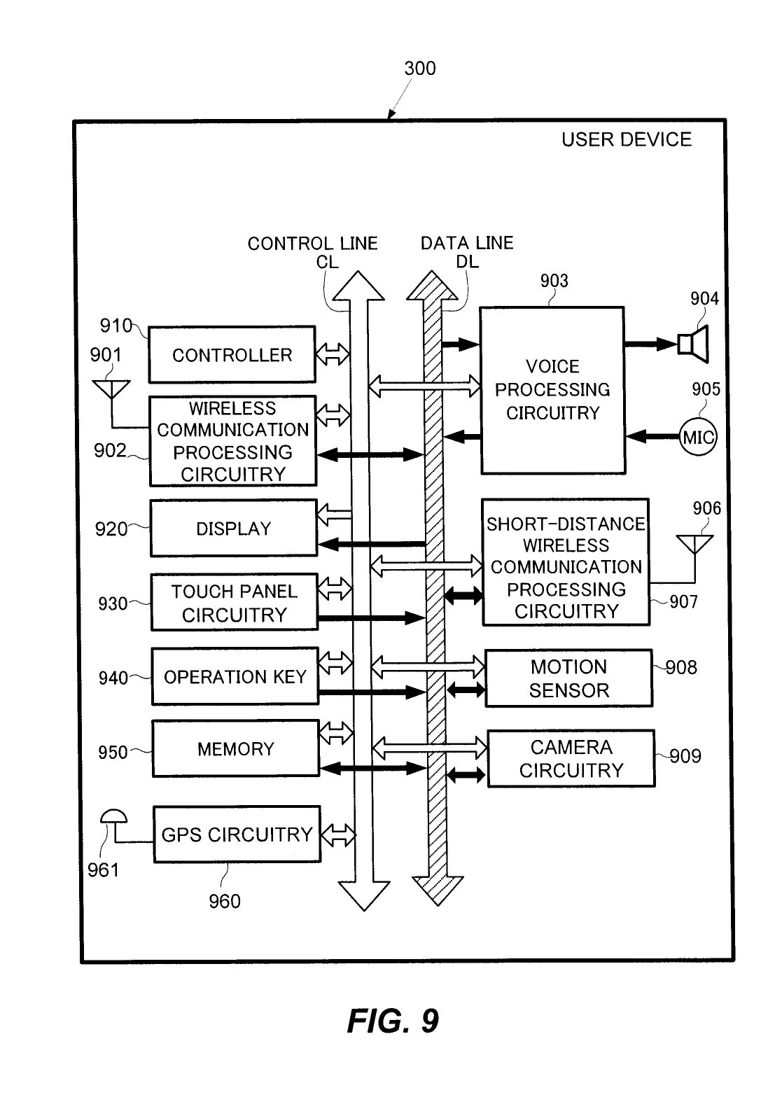

The kiosk 209 can be associated with several sub-clients such as a parking lot 211, an on-street parking 213, a bike 215, a train 217, and a bus 219. All the sub-clients communicate with the server 200 requesting different types of information. For instance, the customer 203 via the DAS app on the user device 300 can request the server 200 for the real-time information from the kiosk 209 regarding the parking lot 211 or the bus 219. The merchant 205 via the DAS app may request the server 200 to validate the customer 203 and the customer's parking related tickets. The merchant 205 can validate different types of tickets using the DAS app. For instance, the merchant center Mc can validate parking lots, bike racks, bus, and taxi for a customer all using the DAS app. Several features related to the DAS app can be accessed via interfaces such as the one discussed with reference to FIGS. 3A-3G implemented on the user device 300 such as a smartphone, a tablet or a computer. The hardware of the user device 300 for implementing the DAS app is explained with respect to FIG. 9, while the hardware for implementing process or functionalities (e.g., a merchant validation process) on the server 200 is discussed with respect to FIG. 10.

A merchant validation can be a process of applying one or more discounts, accumulating different discounts, calculating cumulative discounts, awarding reward points that can be used toward parking or transportation discounts. The discount can be a percentage of an initial measure (an amount before applying a discount), a fixed dollar amount, number of reward points accumulated or a combination thereof. The discount can vary based on a day (e.g., a weekend, a holiday, and a weekday), a time period, a particular location, other similar measures, or a combination thereof. The merchant validation is not limited to the above discount types and one or more validation types can be implemented by a particular merchant.

Further, the validation can be applied to one or more modes of transportation such as a bus, train, car, bike, etc. For example, consider a scenario in which a user visits a particular geographical location (e.g., the downtown area) and uses a parking lot to park a car, and a bike to ride to a merchant in the area. The initial measure (payment amount) for car parking can be x dollars (per a particular time period, per hour, etc.), and the initial measure for bike use can be y dollars (per a particular time period, per minute, etc.). After shopping or visiting a merchant in the area, the merchant can validate the car parking and bike usage by applying a discount, for example, 50% of x dollars on the car parking and 90% of y dollars on the bike usage. In one embodiment, the discount can be applied toward a future parking, bike usage, or give store credit or a refund to the user.

FIGS. 3A-3G illustrate a sample interface of the DAS app according to an embodiment of the present disclosure. The DAS interface 300A includes multiple buttons such as a downtown weather button 30w, a merchant button 301, a best route button 303, an on-street parking button 305, and a validate button 307. Each button performs a particular functionality when selected by a user. The DAS interface 300A is not limited to the above buttons and additional features may be implemented.

The merchant button 301 displays a drop-down list of merchants that may be pre-registered with the assess system. When a user selects the merchant button 301, the list of merchants is displayed (for instance, a drop down list of merchants M1-M10 of FIG. 1). The user can select a desired merchant to visit from the list, for example, a merchant M5.

In one embodiment, referring to screen 300F of FIG. 3F, a merchant list along with validation discounts offered by the merchant can be displayed on a different screen (for example, a merchant table 351 in FIG. 3F). Thus, a merchant can be selected based on maximum discount available for desired transit modes. For instance, a movie theater merchant may offer a 90% parking lot discount and 10% bike rental discount, while a restaurant merchant may offer 20% parking lot discount and 100% bike rental discount. Thus, a customer going to the movie can select the movie theater merchant and use the parking lot discount, while a customer going to the restaurant may choose to rent a bike and use the bike rental discount.

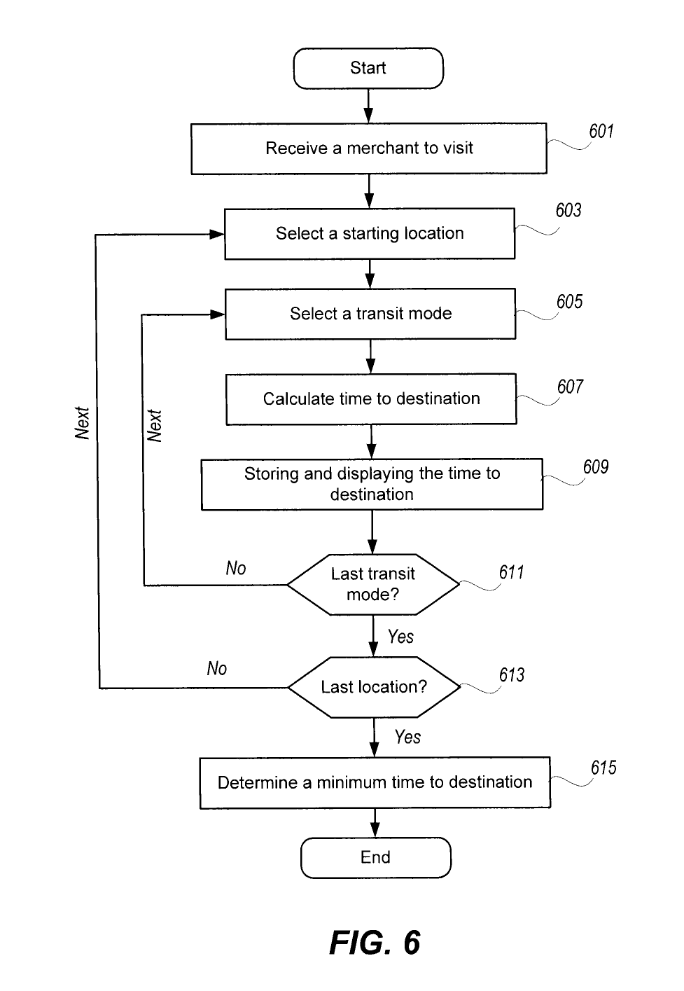

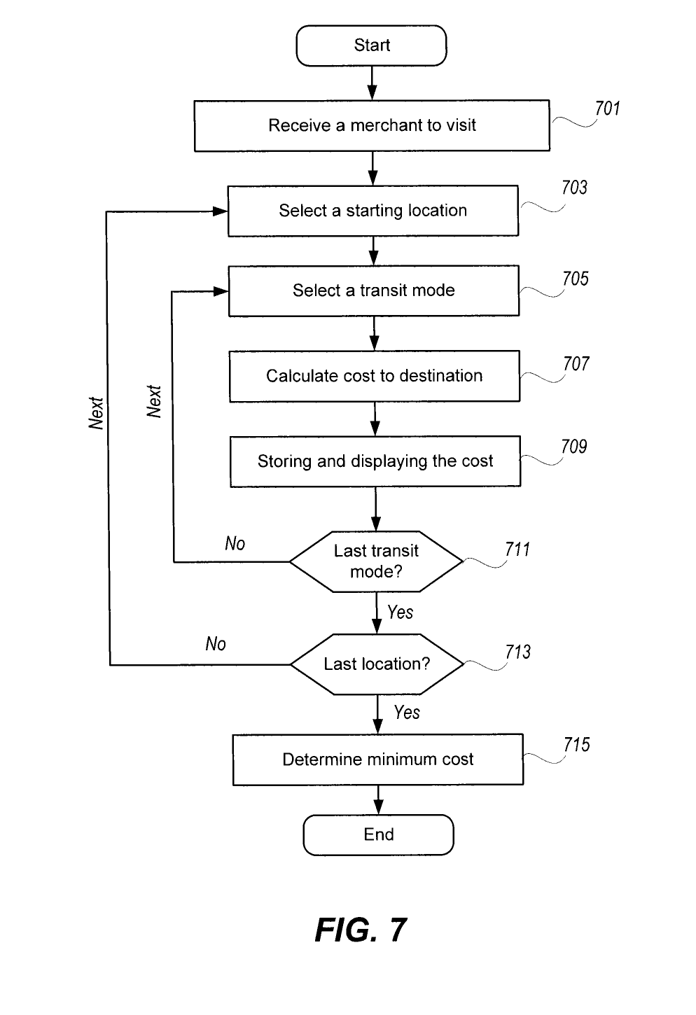

The best route button 303 determines optimal routes to reach the selected merchant. The optimal routes are displayed in a best route interface 300B, shown in FIG. 3B. The optimal route can be determined in two different ways. First, optimal routes can be based on the time required to reach the selected merchant using different transit modes and secondly optimal routes can be based on the cost of taking different paths. A time-based option 309 and a cost-based option 315 display the two different options and a corresponding list of time-based paths 311 and cost-based paths 317, respectively. For example, the time-based option 309 displays four paths along with the time taken by each path. Path1 will take time T1, path2 will take time T2, path3 will take time T3, and path4 will take time T4. Similarly, the cost-based option 315 displays four paths along with the cost accrued by each path. Path5 will cost C1, path6 will cost C2, path7 will cost C3, and path8 will cost C4. Additionally, a merchant code discount can be applied to the calculation to provide a more accurate cost. Further, each of the paths can be selected to see the details of a path such as the mode of transportation, and the parking lot. The algorithms to determine optimal routes are discussed with respect to FIGS. 6 and 7.

In one embodiment, referring to screen 300G of FIG. 3G, path selection can be based on a start destination 361 and end destination 363 predetermined by a user. The start destination 361 can be a current location or a location such as a parking lot or a merchant. Similarly, the end destination 363 can be a current location or a downtown location such as a parking lot or a merchant. Further, real-time traffic information including traffic jams, accidents, construction work etc., can be taken into account while determining the optimal possible route.

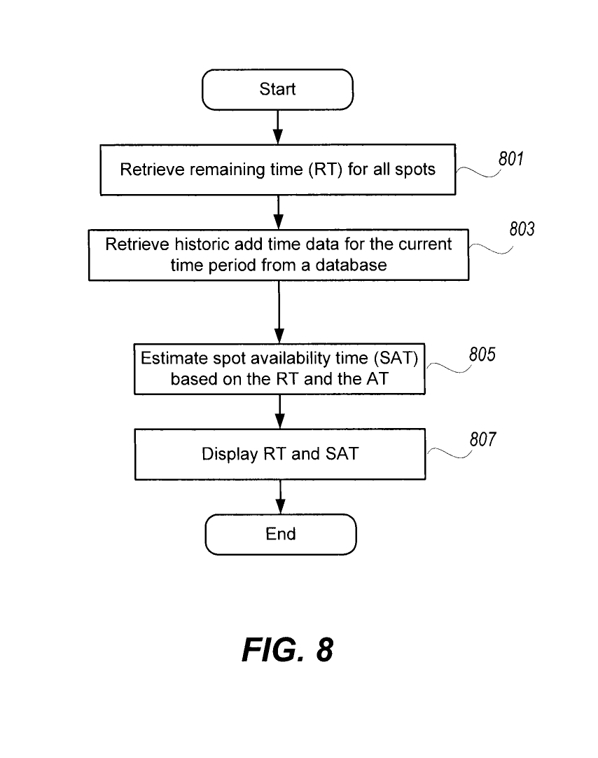

The on-street parking button 305 (in FIG. 3A) determines availability of on-street parking spots. When the user selects the on-street parking button 305, an on-street interface 300C screen appears with a parking spot list 321 showing a remaining time for each spot as shown in FIG. 3C. The remaining time is an amount of time remaining before expiration of a maximum allowed time to park a car at an on-street parking spot. The remaining time may or may not be extended by the user. When the remaining time ends, the parking spot may become available for other users. The remaining time and the extension of the remaining time can be sent to and stored in the database of the server 200. Further, based on the remaining time and an extension of the remaining time, the server 200 can determine an approximate time after which the parking spot may be available. The server 200 can transmit an estimated available time (amount of time after which a parking spot will be empty for others to park a car) to the user device 300. The process of estimating an available time of the parking spot is discussed with respect to FIG. 8.

Referring back to FIG. 3C, the on-street interface 300C displays that a spot SP1 has a remaining time of RT1 and an estimated available time of AT1, a spot SP2 has a remaining time of RT2 and an estimated available time of AT2, a spot SP3 has a remaining time of RT3 and an estimated available time of AT3, a spot SP4 has a remaining time of RT4 and an estimated available time of AT4.

The validate button 307 (in FIG. 3A) provides various validation options, which are displayed on a different screen such as a validate interface 300D illustrated in FIG. 3D. The validation options include but are not limited to the following buttons: a parking button 325, a bus/train button 327, a bike button 329, and a taxi button 331. Each of the validation buttons is linked to a corresponding kiosk and a merchant code for validation purposes. Each of the validation buttons further provides functionality of customer identification, payment options, adding parking time etc. For example, a parking button 325 can be linked to a parking lot 211 and on-street parking 213 kiosks (in FIG. 2). On selecting the parking button 325, a parking interface 300E appears as shown in FIG. 3E. The parking interface 300E provides a customer identification field such as a license field 335, a bus/train button 327, an option to add parking time such as an update button 339, and a pay button 341. The information related to the customer, merchant, transit mode and parking can be stored in a central database of the server 200.

In one embodiment, different validation and payment options may be available. For instance, a customer who makes a reservation at a restaurant in an area (e.g., the downtown area) can receive a validation discount or coupons in advance. Further, a membership-based discount may be applied such that the customer who participates in a membership program offered by the restaurant can automatically receive a transportation-related discount in the bill. The customer participating in a membership program can be identified using a membership ID. The customer can make payments using a mobile device, a credit card, cash etc. The merchant can provide validation by forwarding a discount to a kiosk or the user device 300, providing cash refund, coupons, etc. Alternately, a merchant or the access system can offer a separate software app for validation, which can be linked to or included in the access system.

The system may also provide parking location or transportation-type recommendations based on an indicated final destination and/or time. In addition, the system can provide cost/time information to the user with the recommendation and/or generate the recommendation based on the cost/time information.

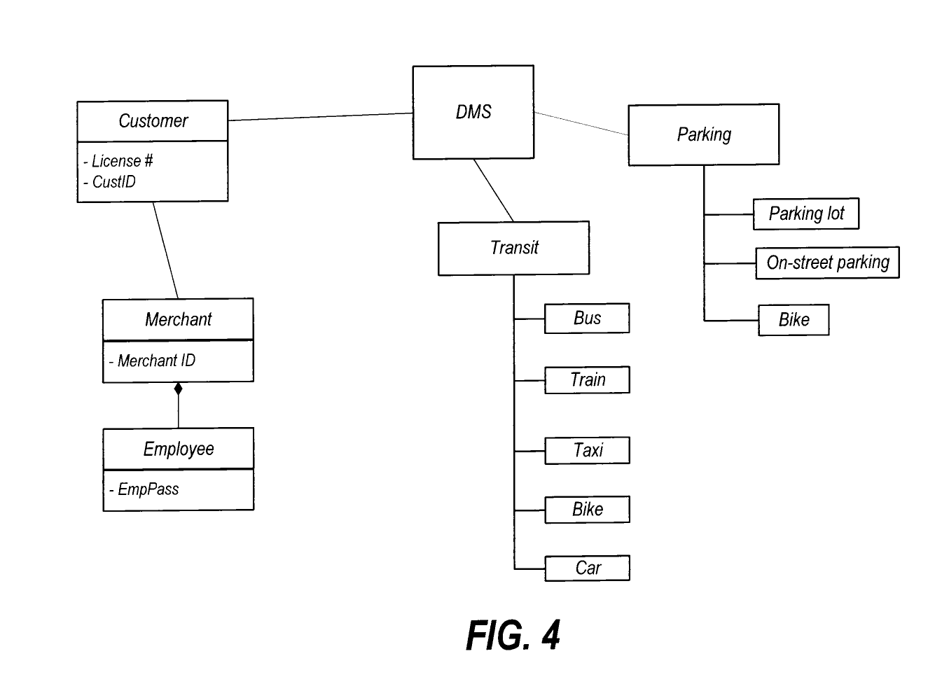

FIG. 4 illustrates a sample database stored on the server 200 according to an embodiment of the present disclosure. The database is represented using a class diagram in which a class represents an abstraction of the real world objects and their properties and a relationship between different classes. The customer class is an abstraction of a real world customer such as John and includes attributes such as an identifier License# and a customer id CustID. A customer class is associated with a database management server (DMS) class and a merchant class indicating that a customer via the user device 300 can communicate with the database of the server 200 and a merchant such as M1. The DMS class is a software abstraction of a central server such as the server 200 in FIG. 2 on which data related to merchants, customers, past and real-time data related to parking, etc. can be stored. The merchant class is an abstraction of a merchant such as merchants M1-M10 and includes a merchant ID to uniquely identify a merchant. The merchant class also includes a discount code DiscCode to validate a ticket of a customer. The merchant class is also related to the DMS class. The merchant class further includes an employee class, which is an abstraction of an employee working at a particular merchant. Each employee has an unique employee pass ID such as EmpPass to validate the ticket of an employee on a daily, weekly, or monthly basis. The transit class includes various subclasses such as bus, train, taxi, bike, or car. Each transit class is attributed with a unique identifier, which can be used for validation purposes by the merchant, a schedule, and location information. A parking class includes different sub-classes such as a parking lot, an on-street parking and a bike class. Each class is attributed with a unique identifier which can be used for validation purposes by the merchant, a schedule, and location information. The above discussion related to the classes is not limited to the attributes and functions discussed herein. Additional attributes and functions can be easily added to enhance the usability and efficiency of the system as needed.

FIG. 5A illustrates a validation process based on user activities according to an embodiment of the present disclosure. The validation process starts when a user activates the user device 300. The user device 300 can be activated as soon as the user opens the DAS app on the user device 300. The validation process can also start when the user pushes the validate button 307 on the interface 300A. The validation process discussed below includes two activities performed at two locations as an example. However, the present disclosure is not limited to two activities or two locations, and the validation process can be easily applied for any number of activities performed at any number of locations.

In step S01, the user device 300 identifies a first location and tracks a first activity performed by the user. The location and activities can be identified using a global positioning sensor, a motion sensor, a camera, or other tracking sensors as illustrated in FIG. 9. Tracking sensors can be installed on the user device 300 or in a certain location of a merchant's store to track activities of the user. The tracking sensors can be configured to automatically detect an entry and exit from a merchant's store, an entry and exit from a particular section of the store, a time of an entry and exit, a duration of visit, etc. The location and activity information can be transmitted from the user device 300 to the server 200 for further processing.

Activities performed by the user at a certain location can be parking a car in a particular parking lot, walking in a particular section of a merchant's store, a particular route inside or outside a particular merchant's store, making a purchase at the merchant, spending a certain amount of time in a particular section of the merchant's store, or other similar activities. Activities performed at a first location can be similar to or different from the activities performed at another location. Furthermore, a time or a day of the first activity can be considered to determine a validation.

In step S03, a first validation can be determined, by the server 200, based on the first activity performed at the first location. For example, the user activity can be parking a car in the parking lot PnR1 at 2 pm and walking in the store of merchant M1 at 3 pm, which can be detected by the user device 300. The initial measure of parking at 2 pm can be a parking amount of 10 dollars, which can be extracted from the database of the server 200. Then, the first validation (e.g., a parking discount of x1% of an initial measure for customer entering a store between 3 pm-5 pm) can be applied by the server 200 and transmitted to the user device 300 from the server 200.

In step S05, the user device 300 identifies a second location and tracks a second activity performed by the user. Further, in step S07, a second validation can be determined, by the server 200, based on the second activity performed at the second location. For example, when the user walks in a first section (e.g., jewelry) of the store of merchant M1 for at least 10 minutes, a second section (e.g., clothing) for at least 15 minutes, etc., then the user device 300 transmits the second activity data to the server 200, where a second validation (e.g., a parking discount of x2 dollars) can be applied. The second validation data can be then transmitted to the user device 300 by the server 200.

In one embodiment, the second validation can be calculated, by the sever 200, based on reward points information stored in the database of the server 200. For example, when the user walks in a first section (e.g., jewelry) for at least 10 mins, 10 reward points can be granted, in a second section (e.g., clothing) for at least 15 mins, 5 reward points can be granted, etc. The reward points can be added and a corresponding discount (e.g., 50 reward points can correspond to a parking discount of x2 dollars) can be applied to determine the second validation.

In step S09, the total validation is calculated by the server 200. The total validation can be a sum of the first validation and the second validation, such that the total validation does not exceed 100% of the initial measure. Once the total validation is calculated, a total measure can be calculated by subtracting the total validation from the initial measure (the payment amount before applying any discount), in step S11. The total measure can be a final amount (including all the discounts/validations) the user must pay for parking, or transportation. For example, the total measure can be a value substantially equal to the initial measure (e.g., 10 dollars) (if no discounts are applied) or a value adjusted for the total validation (e.g., x1*initial measure+x2).

The total measure calculated by the server 200 can be stored in a digital form such as a bar code or a QR code. Further, the total measure can be transmitted to an external device via a network. The external device can be the user device 300, the kiosk 209, etc. Further, the total measure received by the user device 300 in the form of a bar code or QR code can be scanned by the kiosk 209 and a payment can be processed by the user, for example, using the pay button 341 (in FIG. 3E), which allows the user to enter payment information such as credit card details or to extract payment information of the user that is stored on the server 200. Alternatively, the total measure can be sent to the kiosk 209 and the user may follow the payment steps (for instance, pay with credit card, enter credit card details, or pay cash) as prompted by the kiosk 209.

FIG. 5B illustrates a validation process performed by the server 200 according to an embodiment of the present disclosure. The process starts when the user pushes the validate button 307 on the interface 300A. In step 501, the merchant related information is extracted from the database of the server 200. The information may include merchant specific discount codes, validity of codes, type of validation permitted, etc. In step 503, customer identification information such as license number, user id, guest id, membership id, phone number, ticket number, etc., which is entered in the DAS app installed on the user device 300 via an interface such as the parking interface 300E in FIG. 3E, is received by the server 200.

In step 505, the validation type (displayed on the validate interface 300D) requested by the customer is evaluated. The validation type selected on the user device 300 is sent to the server 200 and appropriate merchant discount is applied by the server 200. If the validation type is on-street parking, in step 507, a street parking discount is applied by the server 200. For example, a discount of 20% can be applied to a total street parking charge. If the validation type is off-street parking, in step 509, a street parking discount is applied by the server 200. For example, a discount of 75% can be applied to a total parking charge. If the validation type is Charlottesville Area Transit (CAT) such as a bus or a train, in step 511, a CAT discount is applied by the server 200. For example, a discount of 90% can be applied towards receipt issued by CAT. If the validation type is taxi, in step 513, a taxi discount is applied by the server 200. For example, a discount of 10% can be applied towards the taxi charge. If the validation type is bike parking or bike rental, in step 515, a bike parking or bike rental discount is applied by the server 200. For example, a discount of 100% can be applied to the entire bike usage or a time limit of up to 20 minutes can be set for the bike use. If the validation type is others, in step 517, a relevant discount is applied by the server 200.

FIG. 6 illustrates a time-based route determination algorithm according to an embodiment of the present disclosure. The process starts when the best route 303 (in FIG. 3A) option is selected from the DAS app on the user device 300. In step 601, the server 200 receives a merchant selected by the user on the DAS app. A merchant that the user wants to visit can be selected from the merchant 301 (in FIG. 3A) entered by the user, or the DAS app can extract a list of merchants from the server 200 and prompt the user to select one. Based on the selected merchant, the server 200 can determine possible starting locations and select a starting location, in step 603. Alternatively, the user can enter a starting location on the DAS app of the user device 300 that can be sent to the server 200. The starting location can be, for example, current GPS co-ordinates, location of parking lots PnR1-Pnr4, locations of bike racks BR1-BR4, on-street parking locations, free trolley stops, etc. For each starting location, step 605 is performed in which one of a list of available transit mode options, stored on the database of the server 200, is selected. For instance, the transit mode can be a personal vehicle, a bike from bike racks, free trolley stops, a bus, a train, car sharing, etc., can be retrieved from a database stored on the server 200. For each transit mode, a time to destination is calculated by the server 200, in step 607. The destination is the location of the merchant selected in the step 601. In step 609, the time to destination using one of the starting location and one of the transit mode is stored in the database of the server 200 and displayed on the best route interface 300B of the user device 300, in FIG. 3B. Further, real-time traffic information such as traffic jam, construction, accident, etc. can be taken into account to calculate the time required for different paths.

In step 611, a determination is made by the server 200 whether the last transit mode was the last mode evaluated. If all the transit modes have not been evaluated, the next transit mode is selected and steps 607 and 609 are performed. Once all the transit modes are evaluated and the time to destination is calculated, a check is performed, in step 613, to determine if all starting locations were evaluated. If all the starting locations have not been evaluated, next starting location is selected in step 603. Further, steps 605, 607, 609, and 611 are executed in a loop on the server 200. In another embodiment, only one start and/or end location selected by the user can be used to calculate the transit time. As such, the calculation can be on-demand for different locations, thus improving the processing time and efficiency of the device being used.

Once the time to destination is evaluated for each possible transit mode, in step 615, a path with minimum time to destination is determined and displayed on the DAS screen of the user device 300. Alternately, several paths may be displayed in ascending order of time on the best route interface 300B (in FIG. 3B) of the user device 300. For example, a set of paths are displayed in the time-based paths 311 of FIG. 3B.

FIG. 7 illustrates a cost-based route determination algorithm according to an embodiment of the present disclosure. The process starts when the best route 303 (in FIG. 3A) option is selected from the DAS app on the user device 300. In step 701, a merchant that the user wishes to visit is requested. The merchant can be selected from the merchant 301 (in FIG. 3A) entered by the user, or the DAS app can extract a list of merchants from the server 200 and prompt the user to select one. The selected merchant information can be received by the server 200 from the user device 300. Based on the selected merchant, the server 200 can determine possible starting locations and select a starting location, in step 703. Alternatively, the user can enter a starting location on the DAS app of the user device 300 that can be sent to the server 200. The starting location can be, for example, current GPS co-ordinates, location of parking lots PnR1-Pnr4, locations of bike racks BR1-BR4, on-street parking locations, free trolley stops, etc. For each selected starting location, step 705 is performed by the server 200 wherein, a list of available transit mode options is selected. For instance, the transit mode can be a personal vehicle, a bike from bike racks, free trolley stops, a bus, a train etc., can be retrieved from a database stored on the server 200. For each transit mode, a cost to destination is calculated by the server 200, in step 707. The destination is the location of the merchant. In step 709, the cost to destination using one of the starting location and one of the transit mode is stored in the database of the server 200 and displayed on the best route interface 300B of the user device 300, in FIG. 3B.

In step 711, a determination is made by the server 200 whether the last transit mode was the last mode evaluated. If all the transit modes have not been evaluated, the next transit mode is selected and steps 707 and 709 are performed. Once all the transit modes are evaluated and the cost to destination is calculated, a check is performed, in step 713, to determine if all starting locations were evaluated. If all the starting locations are not evaluated, the next starting location is selected in step 703. Further, steps 705, 707, 709, and 711 are executed in a loop on the server 200. In one embodiment, only one start and/or end location selected by the user can be used to calculate the transit cost. As such, the calculation can be on-demand for different locations, thus improving the processing time and efficiency of the device being used.

Once the cost to destination is evaluated for each possible combination of starting location and transit mode, in step 715, a path with minimum cost to destination is determined and displayed on the DAS screen of the user device 300. Alternately, several paths may be displayed in ascending order of cost on the best route interface 300B (in FIG. 3B) of the user device 300. For example, a set of paths are displayed in the cost-based option 315 of FIG. 3B.

In one embodiment, factors considered in cost calculations can be gas prices in an area where the user is located, car mileage, insurance cost, taxi services, car sharing, etc. For a registered user, information can be extracted from a user database that stores the user identification, car details, mileage details, home address, insurance company, insurance type etc.

In one embodiment, the parking cost can be variable based on the availability of parking. The variable cost structure may encourage visitors or merchant employees to use the off-street parking along with inexpensive or free mass-transit transit modes. Typically, there are more visitors during the evening, holiday seasons, concerts, or during a sale compared to other times of the day or the year. These factors can be taken into account to determine the cost structure for parking. Further, the parking cost structure can be defined based on zones, where the zones close to the downtown area will be available for short-term parking at a higher cost compared to long-term parking zones away from the downtown area. The long-term parking zones can be accessed using free-trolleys, bikes or other inexpensive mass-transits. The long-term parking can be particularly useful for employees of the merchant working in the downtown area. Furthermore, the long-term parking can increase the on-street parking and short-term parking availability, which may increase the number of visitors to the downtown area.

For example, based on the time of the day, the cost structure for parking on-street and off-street with no discount/validation applied is illustrated in table 1. The on-street parking variable cost structure indicates, when parked between 8 AM to 12 PM, the cost of parking for first hour is $2 and after the first hour the cost increases by $3 per hour for each hour after the first hour. Similarly each time slot may have a different cost structure. The cost of parking between the times 4 PM-11 PM can be most expensive.

TABLE 1
Sample variable cost structure for parking
personal vehicle without discount.

| Time | On-street parking | Off-street parking ($12 max) |
|---|---|---|
| 8 AM-12 PM | $2 (for first hr.) + | $2 (for first hr.) + |
| | $3 per hour for | $1.5 per hour for additional hr. |
| | additional hr. | |
| 12 PM-4 PM | $2 * hr | $2 (for first hr.) + |
| | | $1.5 per hour for additional hr. |
| 4 PM-11 PM | $4 (for first hr.) + | $2 (for first hr.) + |
| | $5 per hour for | $1.5 per hour for additional hr. |
| | additional hr. | |
| 11 PM-8 AM | Free | Free |

Further, the cost of parking can be based on the availability of parking on a real-time basis. For instance, using the information about available parking spots, the price of parking can be increased or decreased. For example, if there are many available spots the cost of parking can be set to a lower price or free and when less spots are available the cost can increase. The price could be set at the time of parking or could change (e.g. increase) the longer the user parks as the availability of parking changes (e.g. decreases). This would motivate parkers to use alternate forms of transportation during times of peak use.

Table 2 illustrates the parking cost for 2.5 hours when visiting a merchant that offers a 10% on-street parking discount and a 50% off-street parking discount. The calculations indicate that off-street parking is less expensive than on-street parking at any time of the day. The cost of on-street parking and off-street parking, after applying the discount rates above, when parked for a maximum time (7 hrs.) between 4 PM-11 PM will be approximately $31 and $6, respectively, which indicates that the on-street parking can be approximately $25 more expensive than off-street parking. The discount rate may depend on a merchant, parking time, a mode of transportation, holiday season, zones, etc. The discounts may be applied automatically, as discussed earlier in an embodiment of the present disclosure, during the validation process at a merchant.

TABLE 2
Sample cost for parking for 2.5 hours with discounts applied

| Time | On-street parking | Off-street parking (Max $12) |
|---|---|---|
| 8 AM-12 PM | $6.5 − $(6.5 * 0.1) = | $4.25 − $(4.25 * 0.5) = $2.125 |
| | $5.85 | |
| 12 PM-4 PM | $5 − $(5 * 0.1) = $4.5 | $4.25 − $(4.25 * 0.5) = $2.125 |
| 4 PM-11 PM | $11.5 − $(11.5 * | $4.25 − $(4.25 * 0.5) = $2.125 |
| | 0.1) = $10.35 | |
| 11 PM-8 AM | Free | Free |

The parking users could also be educated of the pricing differences by signage which indicates the current price for parking at different locations. Note that the signage may be disposed inside or outside the parking lots PnR1-PnR4 and/or in the vicinity of the parking lots PnR1-PnR4. For instance, the signage could indicate that an inner zone, a certain area (e.g. up to the parking lot PnR1, in FIG. 1) that is within a predetermined distance from the downtown area, has a price (e.g. variable price—high during peak hours) with the number of spots available and a different price for an outer zone, an area (e.g. the parking lot PnR2 and beyond, in FIG. 1) that is outside the inner zone (beyond the predetermined distance), with the number of spots available. The signage can also indicate the availability of transportation from the outer zone to the inner zone. The signage could also indicate the parking lengths available in the different zones which also could be made variable if needed based on availability. All this information could also be provided via the DAS app.

FIG. 8 illustrates a flow chart for determining a remaining time and an estimated available time for on-street parking according to an embodiment of the present disclosure. In step 801, the remaining time information is retrieved for all the on-street parking spots. The remaining time information is available via the kiosk associated with on-street parking spots. The kiosk communicates the real-time parking information to the server 200 from which the data can be extracted. There may be an option to add time for on-street parking when the requested time limit by a user is reached. Parking time can be also added using the DAS app (on the user device 300). The add time information can be transmitted to and stored in the database of the server 200. In step 803, a historic add time information is retrieved from the database. The historic add time may refer to the time added by a user on different occasions in the past. Based on the historic add time information, a spot availability time (amount of time after which a parking spot will be available for others to park a car) is estimated, in step 805. The remaining time and the estimated spot availability time can be displayed on the DAS screen such as on-street interface 300C, in FIG. 3C.

In one embodiment, parking spot availability at a particular time (such as a restaurant reservation time) for different categories can be determined based on restaurant reservation information. For instance, spot availability in the parking lot, on-street parking, bike parking or bike rental, car sharing rental can be predicted based on number of reservations at a restaurant(s) at a particular time and an average time a customer stays in the restaurant. Further, dedicated parking spots may be available for certain restaurants, which can be taken into account while calculating the spot availability time. Furthermore, weather information at the particular time can be taken into account. In case of a rain prediction, the parking spot availability time may be longer. As such a customer can use the spot availability and weather information to select appropriate reservation time and/or transport mode. These features provide user more flexibility in accessing the downtown area.

Furthermore, the user can be provided with different reservation options based on the parking availability or the parking availability at a number of different times can be provided as information to the user when he or she is selecting a reservation time. This information can help the user determine if parking will not be available or will be less expensive at a certain time. In addition, this information can be displayed to the user in the same display window that the user is selecting a reservation time.

The processes and use of DAS app described above can be illustrated using the following example. Consider that a user plans to visit several merchants M1-M10 in the downtown area from 1 pm to 9 pm on a Saturday. The user opens the DAS app installed on the user device 300 to plan the visit to the downtown area. The user selects the merchant button 301 on the DAS app interface 300A, which sends a signal to the server 200 to extract the list of merchants and the discounts offered on Saturday. The list of merchants and the discounts are sent to the user device 300 and displayed on the merchant interface 300F. The user can then select one of the merchants from the list of merchants, for example, the merchant M10.

Next, the user may choose the best route button 303 on the DAS app interface 300A installed on the user device 300 to determine the optimal option to reach the merchant M10 in the downtown area. The user device 300 sends the signal to the server 200, which executes the algorithms in FIGS. 6 and 7 to determine the optimal time-based path and the optimal cost-based path to the merchant M10. The optimal time-based path can be, for example, a path1 which includes, referring to FIG. 1, driving a car to a parking lot PnR2, riding a bike from bike rack BR3, parking the bike in the bike rack BR1, and walking to the merchant M10. Parking in the parking lot PnR2 and riding the bike may be take less time compared to parking at the parking lot PnR1, since there may be heavy traffic on a Saturday between the parking lot PnR2 to the parking lot PnR1 or parking in the parking lot PnR2 may be less expensive compared to parking lot PnR1. A second time-based path can be, for example, a path2 which includes driving a car to a parking lot PnR4, walking to the trolley TR3 or TR4, and riding the trolley TR3 or TR4 to the merchant M10. The user may choose path1 or path2 based on the number of people travelling. For example, the user may choose path1 if travelling alone, and path2 if travelling with a family of four people.

Furthermore, the server 200 may also determine a different set of cost-based optimal paths, for example, a path5 which includes riding a public transport to from the user's current location (for example, home) to the merchant M10 in the downtown area. A second cost-based optimal path, for example, path6 can include riding a train, followed by riding a trolley TR1 or TR2 to the merchant center Mc, and walking to the merchant M10.

Consider that the user decides to choose the path1. The user arrives in the downtown area at 1 pm and parks the car in the parking lot PnR2 (in FIG. 1). While entering the parking lot PnR1, the user opens the DAS app, and presses the validate button 307 on the DAS app interface 300A of the user device 300 to activate the merchant validation process. The user device 300 starts tracking the first activity using the tracking sensors and sends a signal to the server 200 to inform the server 200 that the user has parked the car in the parking lot PnR2 and a parking charge related to the parking lot PnR2 should be applied starting from 1 pm.

After parking the car, the user picks up a bike from the bike rack BR3 at 1:15 pm. When the user takes the bike from the bike rack BR3, the tracking sensor such as the GPS sensor or the motion sensor on the user device 300 detects a bike usage and sends a signal to the server 200 to apply the bike usage charges. The user rides the bike and parks the bike in the bike rack BR1 at 1:30 pm. The tracking sensor on the user device 300 detects an end of the bike usage and sends a signal to the server 200 that the bike usage has ended. The user may decide to make payment for the bike usage before or after the bike usage through the DAS app on the user device 300, or at a kiosk K8. Alternatively, the user may not make a payment after the bike usage. If the user makes a payment for bike usage, then a signal is sent to the server 200 informing a payment has been made. On the other hand, if the user decides not to make payment for bike usage, then the server 200 can add the bike usage charges to the parking charge. The end of bike usage can be determined as the end of the first activity by the server 200. As such, the location of the first activity would be the full path traversed by the bike from the parking lot PnR2 to the bike rack BR1.

After parking the bike, the user can walk in the merchant M10 store at 2 pm. The tracking sensor on the user device 300 can detect an entry in the merchant M10 store and send a signal to the server 200. The server 200 can determine entry into the merchant M10 store as a beginning of the second activity. The merchant M10 may offer validation and manually enter a validation code on the user device 300 via the validate interface 300D, and the validation code can be sent to the server 200. The validation code can be associated with one or more discounts for different transportation modes such as for car parking, bike usage, etc. that are stored on the server 200 and can be applied towards the validation related to the first activity and the second activity. Alternatively, if the merchant validation data is available on the database of the server 200, then the discounts can be automatically (i.e., without manually entering a validation code) applied by the server 200. For example, the user device 300 can automatically detect the entry in the merchant M10 store and inform the server 200, which then retrieves all the discounts such as a car parking discount, bike usage discount, or reward points offered by the merchant M10 from the database of the server 200 and applies appropriate discounts related to the first activity and the second activity.

Within the merchant M10 store, the user can walk in a clothing section for 30 mins, in a jewelry section for 15 mins, in a bedding section for 20 mins, in a kitchen section for 30 mins, etc. The user device 300 can track the different sections visited and send a signal to the server 200. If the merchant M10 has a reward point system set up for visiting different sections of the store, then the server 200 can grant the corresponding reward points to the user. For example, the user may be granted a total of 50 reward points, which may correspond to a discount of $1 towards car parking. If no reward point system is set up, then the server 200 does not grant reward points based discount. The user can exit the merchant M10 store at 5 pm, which can be detected by the user device 300. As such, discounts, for example, a 50% on car parking corresponding to the time period 2 pm-5 pm and a 90% on bike usage prior to 2 pm, can be applied by the server 200.

The user may visit other merchants in the downtown area, may or may not collect additional discounts and decide to return to the parking lot at 8:30 pm. During return, the activities performed by the user can be tracked using the user device 300 in the similar manner as discussed above. The user may ride the bike from the bike rack BR1 to the bike rack BR3 from 9 pm to 9:15 pm, which can be sent to the server 200 and appropriate charges can be applied. Further, the user may walk to the car and be at the exit of the parking lot PnR2 at 9:30 pm.

At the exit of the parking lot PnR2, the server 200 may determine the initial charges, apply a total validation, and calculate a total payment amount the user has to pay. The initial charges can be, for example, $12 (as per table 1) for car parking between 1 pm to 9:30 pm, $7 for bike usage before 2 pm, and $1 for bike usage after 8 pm. The total validation can be, for example, the 50% discount on initial car parking charges, the 90% discount on the bike usage before 2 pm, and the $1 reward point based discount. The total payment amount calculated will be, for example, a sum of adjusted car parking charges, adjusted bike usage charges, and other discounts. In the above example, the total payment amount will be ($12−0.5*$12)+($7−$7*0.9)+$1−$1, which is equal to $6.50. The total payment amount of $6.50 calculated by the server 200 can be transmitted to the user device 300 in the form of a bar code or QR code, and to the kiosk K2, as discussed earlier in the disclosure. The user may make payments using the pay button 341 of the DAS app interface 300E or payment options available at the kiosk K2.

Each of the functions of the described embodiments may be implemented by one or more processing circuits or controller. A processing circuit includes a programmed processor (for example, controller 910 or a CPU 1000), as a processor includes circuitry. A processing circuit may also include devices such as an application specific integrated circuit (ASIC) and conventional circuit components arranged to perform the recited functions. The processing circuit can be a part of the user device 300 or the server 200 as discussed in more detail with respect to FIGS. 9 and 10.

FIG. 9 is a detailed block diagram illustrating an exemplary user device 300 according to certain embodiments of the present disclosure. In certain embodiments, the user device 300 may be a smartphone. However, the skilled artisan will appreciate that the features described herein may be adapted to be implemented on other devices (e.g., a laptop, a tablet, a server, an e-reader, a camera, a navigation device, etc.). The exemplary user device 300 includes a controller 910 and a wireless communication processing circuitry 902 connected to an antenna 901. A speaker 904 and a microphone 905 are connected to a voice processing circuitry 903.

The controller 910 is an example of the DAS app controller shown in FIGS. 3A-3G and may include one or more Central Processing Units (CPUs), and may control each element in the user device 300 to perform functions related to communication control, audio signal processing, control for the audio signal processing, still and moving image processing and control, and other kinds of signal processing. The controller 910 may perform these functions by executing instructions stored in a memory 950. For example, the processes illustrated in FIGS. 5A, 5B, 6, 7 and 8 may be stored in the memory 950 and executed based on the user inputs received via an interface such as 300A. Alternatively or in addition to the local storage of the memory 950, the functions may be executed using instructions stored on an external device accessed on a network or on a non-transitory computer readable medium.

The memory 950 includes but is not limited to Read Only Memory (ROM), Random Access Memory (RAM), or a memory array including a combination of volatile and non-volatile memory units. The memory 950 may be utilized as working memory by the controller 910 while executing the processes and algorithms of the present disclosure. Additionally, the memory 950 may be used for long-term storage, e.g., of image data and information related thereto. The memory 950 may be configured to store the battle view information, operation view information and list of commands.

The user device 300 includes a control line CL and data line DL as internal communication bus lines. Control data to/from the controller 910 may be transmitted through the control line CL. The data line DL may be used for transmission of voice data, display data, etc.

The antenna 901 transmits/receives electromagnetic wave signals between base stations for performing radio-based communication, such as the various forms of cellular telephone communication. The wireless communication processing circuitry 902 controls the communication performed between the user device 300 and other external devices such as the server 200 (in FIG. 2) or the kiosks K1-K9 (in FIG. 1) via the antenna 901. The wireless communication processing circuitry 902 may control communication between base stations for cellular phone communication.

The speaker 904 emits an audio signal corresponding to audio data supplied from the voice processing circuitry 903. The microphone 905 detects surrounding audio and converts the detected audio into an audio signal. The audio signal may then be output to the voice processing circuitry 903 for further processing. The voice processing circuitry 903 demodulates and/or decodes the audio data read from the memory 950 or audio data received by the wireless communication processing circuitry 902 and/or a short-distance wireless communication processing circuitry 907. Additionally, the voice processing circuitry 903 may decode audio signals obtained by the microphone 905.

The exemplary user device 300 may also include a display 920, a touch panel 930, an operation key 940, and a short-distance communication processing circuitry 907 connected to an antenna 906. The display 920 may be a Liquid Crystal Display (LCD), an organic electroluminescence display panel, or another display screen technology. In addition to displaying still and moving image data, the display 920 may display operational inputs such as the merchant button 301, the best route button 303, the on-street parking button 305, the validate button 307, the time-based option 309, the time-based paths 311, the cost-based option 315, the cost-based paths 317, the parking spot list 321, the parking button 325, the bus/train button 327, the bike button 329, the taxi button 331, the license field 335, the merchant code field 337, the update button 339, the pay button 341 in FIGS. 3A-3G, used for control of the user device 300. The display 920 may additionally display a GUI having multiple screens as shown in FIG. 3A-3E, for a user to control aspects of the user device 300 and/or other devices. Further, the display 920 may display characters and images received by the user device 300 and/or stored in the memory 950 or accessed from an external device on a network such as a camera. For example, the user device 300 may access a network such as the Internet and display text and/or images transmitted from a Web server.

The touch panel 930 may include a physical touch panel display screen and a touch panel driver. The touch panel 930 may include one or more touch sensors for detecting an input operation on an operation surface of the touch panel display screen. The touch panel 930 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus may include a conductive material at least at the tip of the stylus such that the sensors included in the touch panel 930 may detect when the stylus approaches/contacts the operation surface of the touch panel display (similar to the case in which a finger is used for the touch operation).

In certain aspects of the present disclosure, the touch panel 930 may be disposed adjacent to the display 920 (e.g., laminated) or may be formed integrally with the display 920. For simplicity, the present disclosure assumes the touch panel 930 is formed integrally with the display 920 and therefore, examples discussed herein may describe touch operations being performed on the surface of the display 920 rather than the touch panel 930. However, the skilled artisan will appreciate that this is not limiting.

For simplicity, the present disclosure assumes the touch panel 930 is a capacitance-type touch panel technology. However, it should be appreciated that aspects of the present disclosure may easily be applied to other touch panel types (e.g., resistance-type touch panels) with alternate structures. In certain aspects of the present disclosure, the touch panel 930 may include transparent electrode touch sensors arranged in the X-Y direction on the surface of transparent sensor glass.

The touch panel driver may be included in the touch panel 930 for control processing related to the touch panel 930, such as scanning control. For example, the touch panel driver may scan each sensor in an electrostatic capacitance transparent electrode pattern in the X-direction and Y-direction and detect the electrostatic capacitance value of each sensor to determine when a touch operation is performed. The touch panel driver may output a coordinate and corresponding electrostatic capacitance value for each sensor. The touch panel driver may also output a sensor identifier that may be mapped to a coordinate on the touch panel display screen. Additionally, the touch panel driver and touch panel sensors may detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. For example, in certain embodiments, the touch panel 930 may detect a position of a user's finger around an edge of the display panel 920 (e.g., gripping a protective case that surrounds the display/touch panel). Signals may be transmitted by the touch panel driver, e.g. in response to a detection of a touch operation, in response to a query from another element based on timed data exchange, etc.

The touch panel 930 and the display 920 may be surrounded by a protective casing, which may also enclose the other elements included in the user device 300. In certain embodiments, a position of the user's fingers on the protective casing (but not directly on the surface of the display 920) may be detected by the touch panel 930 sensors. Accordingly, the controller 910 may perform display control processing described herein based on the detected position of the user's fingers gripping the casing. For example, an element in an interface may be moved to a new location within the interface (e.g., closer to one or more of the fingers) based on the detected finger position.

Further, in certain embodiments, the controller 910 may be configured to detect which hand is holding the user device 300, based on the detected finger position. For example, the touch panel 930 sensors may detect a plurality of fingers on the left side of the user device 300 (e.g., on an edge of the display 920 or on the protective casing), and detect a single finger on the right side of the user device 300. In this exemplary scenario, the controller 910 may determine that the user is wearing the user device 300 with his/her right hand because the detected grip pattern corresponds to an expected pattern when the user device 300 is wearing only with the right hand.

The operation key 940 may include one or more buttons or similar external control elements, which may generate an operation signal based on a detected input by the user. In addition to outputs from the touch panel 930, these operation signals may be supplied to the controller 910 for performing related processing and control. In certain aspects of the present disclosure, the processing and/or functions associated with external buttons and the like may be performed by the controller 910 in response to an input operation on the touch panel 930 display screens rather than the external button, key, etc. In this way, external buttons on the user device 300 may be eliminated in lieu of performing inputs via touch operations, thereby improving water-tightness.

The antenna 906 may transmit/receive electromagnetic wave signals to/from other external apparatuses, and the short-distance wireless communication processing circuitry 907 may control the wireless communication performed between the other external apparatuses. Bluetooth, IEEE 802.11, and near-field communication (NFC) are non-limiting examples of wireless communication protocols that may be used for inter-device communication via the short-distance wireless communication processing circuitry 907.

The user device 300 may include a motion sensor 908. The motion sensor 908 may detect features of motion (i.e., one or more movements) of the user device 300 or user activities as discussed earlier with reference to FIG. 5A. For example, the motion sensor 908 may include an accelerometer to detect acceleration, a gyroscope to detect angular velocity, a geomagnetic sensor to detect direction, a geo-location sensor to detect location, etc., or a combination thereof to detect motion of the user device 300. In certain embodiments, the motion sensor 908 may generate a detection signal that includes data representing the detected motion. For example, the motion sensor 908 may determine a number of distinct movements in a motion (e.g., from start of the series of movements to the stop, within a predetermined time interval, etc.), a number of physical shocks on the user device 300 (e.g., a jarring, hitting, etc., of the electronic device), a speed and/or acceleration of the motion (instantaneous and/or temporal), or other motion features. The detected motion features may be included in the generated detection signal. The detection signal may be transmitted, e.g., to the controller 910, whereby further processing may be performed based on data included in the detection signal. The motion sensor 908 can work in conjunction with a Global Positioning System (GPS) circuitry 960.

The user device 300 may include a camera circuitry 909, which includes a lens and shutter for capturing photographs of the surroundings around the user device 300. In an embodiment, the camera circuitry 909 captures surroundings of an opposite side of the user device 300 from the user. The images of the captured photographs can be displayed on the display panel 920. A memory circuitry saves the captured photographs. The memory circuitry may reside within the camera circuitry 909 or it may be part of the memory 950. The camera circuitry 909 can be a separate feature attached to the user device 300 or it can be a built-in camera feature. Furthermore, the camera circuitry 909 can be configured to detect features of motion (i.e., one or more movements) of the user device 300 or user activities as discussed earlier with reference to FIG. 5A.

The DAS app implemented on the user device 300 is an application that requests data processing from the server 200. The server 200, in FIG. 10, includes a storage controller 1024 that manages the database on a disk 1004 and a query manager app that executes SQL (structured query language) statements against this data on the disk 1004. The query manager app also implements processing functions (e.g. query syntax analysis, optimization, and execution plan generation) as well as a simple network communication function to send and receive signal from a network controller 1006. A more detailed description of hardware of the server 200 is as follows.

FIG. 10 is a detailed block diagram illustrating an exemplary server 200 according to certain embodiments of the present disclosure. In FIG. 10, the sever 200 includes a CPU 1000 which performs the processes described in the present disclosure. The process data and instructions may be stored in a memory 1002. These processes and instructions (discussed with respect to FIGS. 5A-8) may also be stored on a storage medium disk 1004 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the sever 200 communicates, such as a server or computer.

Further, the claimed advancements may be provided as a utility application, background daemon, or component of an operating system, or combination thereof, executing in conjunction with CPU 1000 and an operating system such as Microsoft Windows 7, UNIX, Solaris, LINUX, Apple MAC-OS and other systems known to those skilled in the art.

The hardware elements in order to achieve the sever 200 may be realized by various circuitry elements, known to those skilled in the art. For example, CPU 1000 may be a Xenon or Core processor from Intel of America or an Opteron processor from AMD of America, or may be other processor types that would be recognized by one of ordinary skill in the art. Alternatively, the CPU 1000 may be implemented on an FPGA, ASIC, PLD or using discrete logic circuits, as one of ordinary skill in the art would recognize. Further, CPU 1000 may be implemented as multiple processors cooperatively working in parallel to perform the instructions of the inventive processes described above with respect to FIGS. 5A-8.

The sever 200, in FIG. 10, also includes the network controller 1006, such as an Intel Ethernet PRO network interface card from Intel Corporation of America, for interfacing with a network 1020. As can be appreciated, the network 1020 can be a public network, such as the Internet, or a private network such as an LAN or WAN network, or any combination thereof and can also include PSTN or ISDN sub-networks. The network 1020 can also be wired, such as an Ethernet network, or can be wireless such as a cellular network including EDGE, 3G and 4G wireless cellular systems. The wireless network can also be WiFi, Bluetooth, or any other wireless form of communication that is known. The server 200 can communicate with external devices such as the user device 300, the kiosk 209, etc. via the network controller 1020.

The sever 200 further includes a display controller 1008, such as a NVIDIA GeForce GTX or Quadro graphics adaptor from NVIDIA Corporation of America for interfacing with display 920. The display 920 can be display of the user device 300 or a signage displayed outside the parking lots PnR1-PnR4. An I/O interface 1012 interfaces with a keyboard and/or mouse 1014 as well as a touch screen panel 1016 on or separate from display 920. The I/O interface also connects to a variety of peripherals 1018 including printers and scanners, such as an OfficeJet or DeskJet from Hewlett Packard. Further, the server 200 can be connected to the user device 300 or the kiosk 209 via I/O interface 1012 or through the network 1020. The user device 300 can send queries that are handled by the query manager application 1050 including extracting data from the disk 1004 via the storage controller 1024, from the memory 1002, or trigger execution of processes discussed in FIGS. 5A, 5B, 6, 7 and 8.

The storage controller 1024 connects the storage medium disk 1004 with communication bus 1026, which may be an ISA, EISA, VESA, PCI, or similar, for interconnecting all of the components of the sever 200. A description of the general features and functionality of the display 920, keyboard and/or mouse 1014, as well as the display controller 1008, storage controller 1024, network controller 1006, and the I/O interface 1012 is omitted herein for brevity as these features are known.

In the above description, any processes, descriptions or blocks in flowcharts should be understood as representing modules, segments or portions of code which include one or more executable instructions for implementing specific logical functions or steps in the process, and alternate implementations are included within the scope of the exemplary embodiments of the present advancements in which functions can be executed out of order from that shown or discussed, including substantially concurrently or in reverse order, depending upon the functionality involved, as would be understood by those skilled in the art. The various elements, features, and processes described herein may be used independently of one another, or may be combined in various ways. All possible combinations and subcombinations are intended to fall within the scope of this disclosure.

While certain embodiments have been described, these embodiments have been presented by way of example only, and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosure. The accompanying claims and their equivalents are intended to cover such forms or modifications as would fall within the scope and spirit of the present disclosure. For example, this technology may be structured for cloud computing whereby a single function is shared and processed in collaboration among a plurality of apparatuses via a network.

What is claimed is:

1. An apparatus implementing a server-centric architecture, the apparatus comprising:
processing circuitry configured to determine a first validation based on a first activity performed at a first location,
which is determined based on a sensor of an external device that is external to the apparatus, determine a second validation based on a second activity performed at a second location, which is determined based on the sensor of the external device, the second location being different from the first location,
compute a total validation by aggregating the first validation and the second validation,
calculate a total measure by adjusting an initial measure by the total validation, the initial measure corresponding to an amount that fluctuates based on predetermined conditions associated with a time of day and total amount of time spent at a geographical location that includes the first location and the second location, and
transmit, via a network, the calculated total measure to the external device.
